(19) United States
(12) Patent Application Publication
(10) Pub. No.: US 2018/0369723 A1
(43) Pub. Date: Dec. 27, 2018

(54) METHOD FOR OPERATING FILTRATION APPARATUS AND FILTRATION APPARATUS

(71) Applicant: SUMITOMO ELECTRIC INDUSTRIES, LTD., Osaka-shi, Osaka (JP)

(72) Inventors: Hiroko MIKI, Sennan-gun, Osaka (JP); Hiromu TANAKA, Sennan-gun, Osaka (JP); Takayuki NISHIURA, Sennan-gun, Osaka (JP); Kenichi USHIKOSHI, Sennan-gun, Osaka (JP); Kiyoshi IDA, Sennan-gun, Osaka (JP); Toru MORITA, Sennan-gun, Osaka (JP)

(73) Assignee: SUMITOMO ELECTRIC INDUSTRIES, LTD., Osaka-shi, Osaka (JP)

(21) Appl. No.: 16/064,011

(22) PCT Filed: Jan. 9, 2017
(86) PCT No.: PCT/JP2017/000355

§ 371 Date: Jun. 20, 2018

(30) Foreign Application Priority Data
Jan. 22, 2016 (JP) 2016-011023

(51) Int. Cl. B01D 29/66; B01D 35/12; B01D 65/02; C02F 1/44

(52) U.S. Cl. CPC B01D 29/663; B01D 35/12; B01D 65/08; C02F 1/44; B01D 65/022

(57) ABSTRACT

A method for operating a filtration apparatus according to an aspect of the present invention is a method for operating a filtration apparatus including three or more filtration modules, the method including a filtration step in which a filtration treatment is performed using the filtration modules and a cleaning step in which some of the filtration modules are stopped from performing the filtration treatment and the filtration modules stopped from performing the filtration treatment are cleaned simultaneously. A filtration apparatus according to another aspect of the present invention is a filtration apparatus including three or more filtration modules, a collection system that collects a filtrate from the filtration modules, and a cleaning system that cleans some of the filtration modules simultaneously.

### TECHNICAL FIELD

The present invention relates to a method for operating a filtration apparatus and a filtration apparatus.

The present application claims a priority to Japanese Patent Application No. 2016-011023 filed on Jan. 22, 2016, which is incorporated herein by reference in its entirety.

### BACKGROUND ART

A filtration apparatus that includes filtration modules including bundles of a plurality of filtration membranes, such as hollow fiber membranes (see Japanese Unexamined Patent Application Publication No. 2015-6653), has been used as a solid-liquid separation apparatus in a wastewater treatment or in the production of medicines or the like.

In a filtration treatment, the filtration modules are immersed in a liquid that is to be treated and allow substances other than impurities included in the liquid that is to be treated to permeate into the insides of the permeation membranes while blocking the permeation of the impurities on the surfaces of the filtration membranes.

However, since such filtration apparatuses block the permeation of impurities included in the liquid, which is to be treated, on the surfaces of the filtration membranes, performing the filtration treatment continuously may cause the surfaces of the filtration membranes to be contaminated with the impurities adhered thereon. That is, fouling of the membranes may occur. Accordingly, in such filtration apparatuses, cleaning is performed on an as-needed basis and the operation of filtration treatment is performed in an intermittent manner in order to prevent fouling of the membranes. One of the cleaning methods commonly used in such cleaning is backwashing by in-line cleaning. In in-line cleaning, cleaning is performed by injecting cleaning water, a mixture of cleaning water and a chemical, or the like into hollow fiber membranes so as to pass the cleaning water or the like through the hollow fiber membranes in the direction from the insides of the membranes to the outsides of the membranes.

### CITATION LIST

### Patent Literature

PTL 1: Japanese Unexamined Patent Application Publication No. 2015-6653

### SUMMARY OF INVENTION

A method for operating a filtration apparatus according to an aspect of the present invention is a method for operating a filtration apparatus including three or more filtration modules, the method including a filtration step in which a filtration treatment is performed using the filtration modules and a cleaning step in which some of the filtration modules are stopped from performing the filtration treatment and the filtration modules stopped from performing the filtration treatment are cleaned simultaneously.

A filtration apparatus according to another aspect of the present invention is a filtration apparatus including three or more filtration modules, a collection system that collects a filtrate from the filtration modules, and a cleaning system that cleans some of the filtration modules simultaneously.

### BRIEF DESCRIPTION OF DRAWINGS

FIG. 1 is a diagram schematically illustrating the structure of a filtration apparatus according to an embodiment of the present invention.

FIG. 2 is a diagram schematically illustrating the method for operating the filtration apparatus illustrated in FIG. 1.

FIG. 3 is a diagram schematically illustrating the structure of a filtration apparatus according to an embodiment other than that illustrated in FIG. 1.

### DESCRIPTION OF EMBODIMENTS

### Technical Problems to be Solved by the Present Disclosure

In general, a filtration apparatus includes a plurality of filtration modules that perform a filtration treatment simultaneously. When the degree of cleaning (i.e., the degree of contamination) varies among the plurality of filtration modules, a less heavily contaminated filtration module has a smaller pressure loss than a more heavily contaminated filtration module and, consequently, the amount of treated liquid drawn with the less heavily contaminated filtration module by suction is increased. This causes an unintended load to be put on the less heavily contaminated filtration module and results in, for example, a reduction in service life.

The present invention was made in light of the above issues. An object of the present invention is to provide a method for operating a filtration apparatus including a plurality of filtration modules with which an imbalance in load among the filtration modules can be reduced and such a filtration apparatus.

### Description of the Embodiments

A method for operating a filtration apparatus according to an aspect of the present invention is a method for operating a filtration apparatus including three or more filtration modules, the method including a filtration step in which a filtration treatment is performed using the filtration modules and a cleaning step in which some of the filtration modules are stopped from performing the filtration treatment and the filtration modules stopped from performing the filtration treatment are cleaned simultaneously.

In the method for operating a filtration apparatus, the filtration apparatus includes three or more filtration modules, and only a part of the filtration modules are cleaned while the filtration treatment is continued with the other filtration modules that are not cleaned. In the method for operating a filtration apparatus, a plurality of filtration modules are cleaned simultaneously. This enables the plurality of filtration modules to be cleaned at the same timing and makes the degrees of contamination of the filtration modules equal. As a result, an imbalance in load among the filtration modules can be reduced and, consequently, the service life of the filtration modules can be increased. Furthermore, in the above cleaning step, the amount of time required for cleaning all the filtration modules can be reduced compared with the case where the filtration modules are cleaned one by one. This reduces the amount of time during which the filtration treatment is performed under the condition where the degree of contamination varies among a plurality of filtration modules.

In the above cleaning step, a plurality of filtration modules that have not been cleaned for the same or nearly the same amount of time as one another may be cleaned simultaneously. Simultaneously cleaning a plurality of filtration modules that have not been cleaned for the same or nearly the same amount of time as one another reduces variations in the degree of contamination among filtration modules that continue the filtration treatment without being cleaned. This reduces an imbalance in load among a part of the filtration modules which may occur while the other filtration modules are cleaned. The expression “nearly the same amount of time” used herein means that a difference between the amounts of time during which the filtration modules have not been cleaned is 5% or less and is preferably 1% or less.

The total number of filtration modules included in the filtration apparatus may be even, and half of all the filtration modules may be cleaned simultaneously in the cleaning step. When the number of the filtration modules is even and half of the filtration modules are cleaned simultaneously, all the filtration modules can be cleaned in two cleaning steps. This further reduces the amount of time required for cleaning. Furthermore, while half of the filtration modules are cleaned, the other half of the filtration modules can be used for performing the filtration treatment. This enables a treatment capacity equal to 50% or more of that achieved while the cleaning step is not conducted (i.e., during normal operation) to be maintained even while some of the filtration modules are cleaned.

The amount of time during which cleaning is performed in the cleaning step is preferably 0.3% or more and 5% or less of the amount of time during which the filtration treatment is performed. Setting the amount of the above cleaning time to fall within the above range further reduces a difference in the degree of contamination between modules cleaned first and modules cleaned last.

A filtration apparatus according to another aspect of the present invention is a filtration apparatus including three or more filtration modules, a collection system that collects a filtrate from the filtration modules, and a cleaning system that cleans some of the filtration modules simultaneously.

The filtration apparatus includes three or more filtration modules and cleans some of the filtration modules while continuing the filtration treatment with the other filtration modules that are not cleaned.

The filtration apparatus cleans a plurality of filtration modules simultaneously. This enables the plurality of filtration modules to be cleaned at the same timing and makes the degrees of contamination of the filtration modules equal. As a result, an imbalance in load among the filtration modules can be reduced and, consequently, the service life of the filtration modules can be increased. Furthermore, since the filtration apparatus is capable of cleaning a plurality of filtration modules simultaneously, the amount of time required for cleaning all the filtration modules can be reduced compared with the case where the filtration modules are cleaned one by one. This reduces the amount of time during which the filtration treatment is performed under the condition where the degree of contamination varies among a plurality of filtration modules.

### Advantageous Effects of the Present Disclosure

The method for operating a filtration apparatus and a filtration apparatus according to aspects of the present invention may reduce an imbalance in load among a plurality of filtration modules.

### Detailed Description of the Embodiments

A filtration apparatus and a method for operating a filtration apparatus according to embodiments of the present invention are described below with reference to the attached drawings.

### [Filtration Apparatus According to First Embodiment]

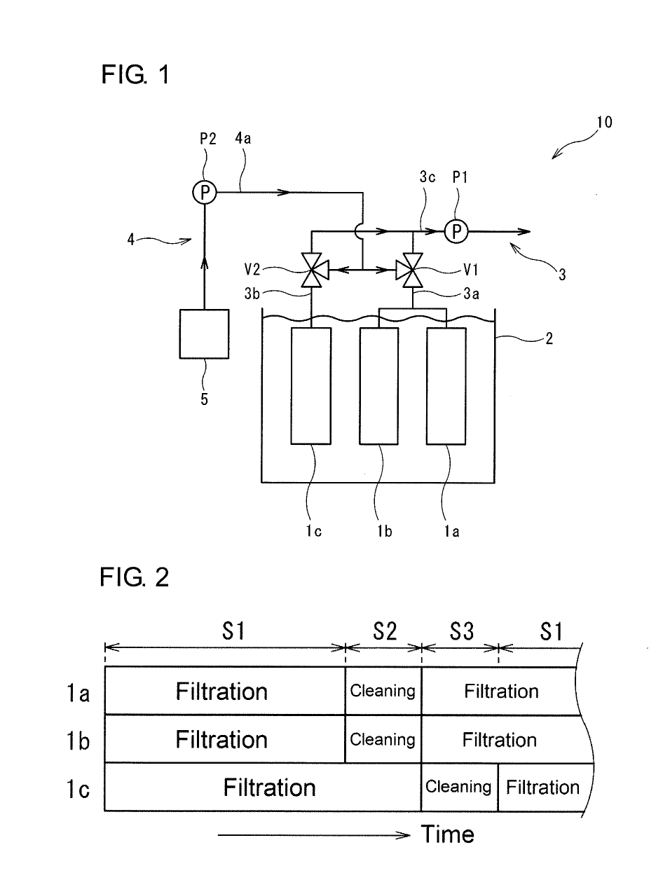

The filtration apparatus 10 illustrated in FIG. 1 primarily includes three filtration modules, a collection system that collects a filtrate from the filtration modules, and a cleaning system that cleans the filtration modules.

### <Filtration Modules>

The filtration apparatus 10 includes three filtration modules (i.e., a first filtration module 1a, a second filtration module 1b, and a third filtration module 1c). Each of the filtration modules is immersed in a liquid that is to be treated, which is stored in a water tank 2, and connected to a collection pipe 3 included in the collection system described below and to a cleaning pipe 4 included in the cleaning system described below.

Each of the filtration modules includes filtration membranes. The filtration membranes are not limited and may be any filtration membranes through which impurities included in the liquid that is to be treated can be separated. Specific examples of the structure of the filtration modules include a structure in which a plurality of hollow fiber membranes are arranged in a curtain-like manner between upper and lower holding members. Each of the filtration modules may include a block constituted by a plurality of filtration modules bound with a common portion such as a water-collection pipe.

The filtration membranes included in each of the filtration modules are porous membranes that allow water to permeate therethrough and block impurities included in water that is to be treated from permeating therethrough. The filtration membranes may be composed of a thermoplastic resin. Examples of the thermoplastic resin include polyethylene, polypropylene, polyvinylidene fluoride, an ethylene-vinyl alcohol copolymer, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). Among the above thermoplastic resins, polyvinylidene fluoride and PTFE are preferable.

### <Collection System>

The collection system included in the filtration apparatus 10 constitutes a suction system with which the treated water is drawn from the plurality of filtration modules by suction. The collection system primarily includes a collection pipe 3 connected to each of the filtration modules, through which the treated water is collected from the filtration modules, and a suction pump P1 disposed on the collection pipe 3, with which the treated water is collected by suction.

The collection pipe 3 includes a first pipe 3a through which the treated water is collected from two filtration modules, that is, the first filtration module 1a and the second filtration module 1b, simultaneously in parallel, a second pipe 3b through which the treated water is collected from only the third filtration module 1c, and a main pipe 3c with which the first pipe 3a and the second pipe 3b are connected to the suction pump P1.

Switching systems (i.e., a first three-way valve V1 and a second three-way valve V2) used for a switchover to the connection to a main pipe 4a included in the cleaning pipe 4 described below are interposed between the first pipe 3a and the main pipe 3c and between the second pipe 3b and the main pipe 3c, respectively. In other words, the first pipe 3a or the second pipe 3b, the main pipe 3c of the collection pipe 3, and the main pipe 4a of the cleaning pipe 4, which is described below, are connected to the joints of the switching systems (i.e., the three-way valves). Note that the switching systems are not limited to three-way valves and may be constituted by a plurality of gate valves.

### <Cleaning System>

The cleaning system included in the filtration apparatus 10 primarily includes a cleaning pipe 4 through which cleaning water is fed to the plurality of filtration modules, a cleaning water tank 5 connected to the cleaning pipe 4, in which the cleaning water is stored, and a feed pump P2 disposed on the cleaning pipe 4, with which the cleaning water is fed to the filtration modules by the application of pressure.

The cleaning pipe 4 includes a main pipe 4a with which the cleaning water tank 5 is connected to the first three-way valve V1 and the second three-way valve V2. The cleaning pipe 4 also includes the first pipe 3a and the second pipe 3b that are shared with the collection pipe 3 and serve as lines with which the cleaning pipe 4 is connected to the respective filtration modules. In other words, the cleaning pipe 4 includes the first pipe 3a and the second pipe 3b. The above pipes constitute lines through which the cleaning water is fed from the cleaning water tank 5 to each of the filtration modules. Accordingly, the two filtration modules, that is, the first filtration module 1a and the second filtration module 1b, are supplied with the cleaning water simultaneously in parallel through the first pipe 3a, while only the third filtration module 1c is supplied with the cleaning water through the second pipe 3b.

The above-described structure of the cleaning pipe 4 enables the cleaning system of the filtration apparatus 10 to clean some of the filtration modules (i.e., the first filtration module 1a and the second filtration module 1b) simultaneously.

Examples of the cleaning water stored in the cleaning water tank 5 include water treated with the filtration modules and a chemical solution including a cleaning chemical. Specifically, a structure including a tank that stores the treated water and a tank that stores a chemical, which serve as a cleaning water tank 5, and feed pumps each connected to a specific one of the tanks, in which the treated water and the chemical are fed from the respective tanks to the filtration modules with the respective feed pumps while being mixed with each other, may be used. The above structure enables the filtration membranes included in the filtration modules to be cleaned in a suitable manner.

### [Method for Operating Filtration Apparatus]

A method for operating a filtration apparatus according to an embodiment of the present invention in which the filtration apparatus 10 is used is described below.

As described in FIG. 2, the method for operating a filtration apparatus includes a filtration step S1 in which a filtration treatment is performed using the above filtration modules, a first cleaning step S2 in which some of the filtration modules are stopped from performing the filtration treatment and the plurality of filtration modules stopped from performing the filtration treatment are cleaned simultaneously, and a second cleaning step S3 in which the other filtration modules that are not cleaned in the first cleaning step S2 are stopped from performing the filtration treatment and the filtration modules stopped from performing the filtration treatment are cleaned.

### <Filtration Step>

In the filtration step S1, a filtration treatment of water that is to be treated is performed using a plurality of filtration modules and the collection system in order to produce treated water.

In the filtration step S1, all the filtration modules are used for performing the filtration treatment. Specifically, the first three-way valve V1 and the second three-way valve V2 are both controlled such that the filtration modules are connected to the main pipe 3c of the collection pipe 3, and treated water is collected from the first filtration module 1a, the second filtration module 1b, and the third filtration module 1c.

### <First Cleaning Step>

In the first cleaning step S2, some of the filtration modules are stopped from performing the filtration treatment and the plurality of filtration modules stopped from performing the filtration treatment are cleaned simultaneously. In the filtration apparatus 10, stopping the first filtration module 1a and the second filtration module 1b from performing the filtration treatment and cleaning the first filtration module 1a and the second filtration module 1b corresponds to the first cleaning step S2. In this cleaning, the first three-way valve V1 is controlled such that the first filtration module 1a and the second filtration module 1b are connected to the main pipe 4a of the cleaning pipe 4 in the above-described manner, and the cleaning water is fed to the above filtration modules.

While the first cleaning step S2 is conducted, the filtration treatment is continued using the other filtration modules that are not cleaned. In the case where the first filtration module 1a and the second filtration module 1b are cleaned in the first cleaning step S2, in this step, the filtration treatment is performed using only the third filtration module 1c. Specifically, in addition to the control of the first three-way valve V1, the second three-way valve V2 is controlled such that the third filtration module 1c is connected to the main pipe 3c of the collection pipe 3.

### <Second Cleaning Step>

In the second cleaning step S3, the other filtration modules that are not cleaned in the first cleaning step S2 are stopped from performing the filtration treatment and subsequently cleaned. In the filtration apparatus 10, stopping the third filtration module 1c from performing the filtration treatment and cleaning the third filtration module 1c correspond to the second cleaning step S3. In this cleaning, the second three-way valve V2 is controlled such that the third filtration module 1c is connected to the main pipe 4a of the cleaning pipe 4 and the cleaning water is fed to the third filtration module 1c. While the second cleaning step S3 is conducted, the filtration treatment is continued using the other filtration modules that have been cleaned in the first cleaning step S2, that is, the first filtration module 1a and the second filtration module 1b.

The order in which the first cleaning step S2 and the second cleaning step S3 are conducted is not limited. The first cleaning step S2 may be conducted prior to the second cleaning step S3 as described in FIG. 2. Alternatively, the second cleaning step S3 may be conducted prior to the first cleaning step S2. It is preferable to continuously conduct the first cleaning step S2 and the second cleaning step S3 in order to reduce the amount of time required for cleaning all the filtration modules and differences in the degree of contamination among the filtration modules.

In the cleaning step (i.e., the first cleaning step S2 or the second cleaning step S3) conducted first, it is preferable to clean filtration modules that have not been cleaned for the largest amount of time (i.e., the most heavily contaminated). This improves the efficiency of the filtration treatment.

In the method for operating a filtration apparatus, subsequent to the first cleaning step S2 and the second cleaning step S3, the filtration step S1 is conducted again and, after a lapse of a certain amount of time, the cleaning (i.e., the first cleaning step S2 and the second cleaning step S3) is performed again. The above cycle of the steps is repeated.

In the method for operating a filtration apparatus, only a part of the filtration modules (i.e., the first filtration module 1a and the second filtration module 1b) are cleaned, while the filtration treatment is continued using the other filtration module (i.e., the third filtration module 1c) that is not cleaned. In the method for operating a filtration apparatus, a plurality of filtration modules are cleaned simultaneously. This enables the plurality of filtration modules to be cleaned at the same timing and, consequently, makes the degrees of contamination of the filtration modules equal. As a result, an imbalance in load among the filtration modules can be reduced and, consequently, the service life of the filtration modules can be increased. Furthermore, since the method for operating a filtration apparatus includes the first cleaning step S1 in which a plurality of filtration modules are cleaned simultaneously, the amount of time required for cleaning all the filtration modules can be reduced compared with the case where the filtration modules are cleaned one by one. This reduces the amount of time during which a filtration treatment is performed under the condition where the degree of contamination varies among a plurality of filtration modules.

In the filtration apparatus 10, the pump for cleaning (i.e., the feed pump P2) can be shared among a plurality of filtration modules. This reduces the facility costs, the facility space, and the like.

In the method for operating a filtration apparatus, the first cleaning step S2 is always conducted using the first filtration module 1a and the second filtration module 1b in combination. In other words, in the method for operating a filtration apparatus, simultaneous cleaning of a plurality of filtration modules that have not been cleaned for the same or nearly the same amount of time as one another (i.e., in the first cleaning step S2) is repeated. This reduces variations in the degree of contamination between the first filtration module 1a and the second filtration module 1b which may occur when the filtration treatment is continued using the two filtration modules during the cleaning of the third filtration module 1c (i.e., the second cleaning step S3) and, as a result, reduces an imbalance in load between the two filtration modules.

The lower limit for the amount of time during which cleaning is performed in the first cleaning step S2 and the second cleaning step S3 is preferably 0.3% and is more preferably 0.5% of the amount of time during which the filtration treatment is performed. The upper limit for the amount of the above cleaning time is preferably 5% and is more preferably 4% of the amount of the above filtration treatment time. If the amount of the cleaning time is smaller than the lower limit, it may not be possible to perform cleaning to a sufficient degree. Conversely, if the amount of the cleaning time is larger than the upper limit, the treatment efficiency may become degraded.

### [Filtration Apparatus According to Second Embodiment]

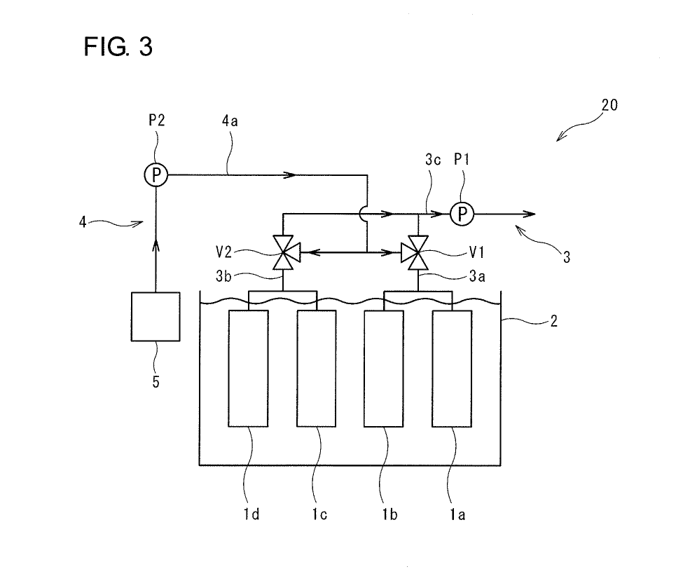

The filtration apparatus 20 illustrated in FIG. 3 primarily includes four filtration modules (i.e., a first filtration module 1a, a second filtration module 1b, a third filtration module 1c, and a fourth filtration module 1d), a collection system that collects a filtrate from the filtration modules, and a cleaning system that cleans the filtration modules. The filtration apparatus illustrated in FIG. 3 has the same structure as the filtration apparatus 10 illustrated in FIG. 1, except that the number of the filtration modules is changed to four. Therefore, duplicate descriptions are omitted.

In the filtration apparatus 20, the second pipe 3b is connected to the third filtration module 1c and the fourth filtration module 1d. In other words, the filtration apparatus 20 is configured to be capable of cleaning the third filtration module 1c and the fourth filtration module 1d simultaneously.

Since the total number of the filtration modules included in the filtration apparatus 20 is even, all the filtration modules can be cleaned in two cleaning steps when half (i.e., two) of all the filtration modules are cleaned simultaneously in one cleaning step. This reduces the amount of time required for cleaning all the filtration modules. In addition, while two filtration modules are cleaned, it is possible to perform the filtration treatment using the other two filtration modules. This enables a treatment capacity equal to 50% or more of that achieved while the cleaning step is not conducted (i.e., during normal operation) to be maintained even while some of the filtration modules are cleaned. In other words, unlike the filtration apparatus 10 illustrated in FIG. 1, it is not necessary for the filtration apparatus 20 to conduct the second cleaning step in which a single filtration module is cleaned.

### Other Embodiments

The embodiments disclosed herein are to be considered in all respects as illustrative and not restrictive. The scope of the present invention is indicated by the appended claims rather than by the structures described in the foregoing embodiments. All changes which come within the meaning and range of equivalency of the claims are therefore intended to be embraced therein.

The filtration apparatus may include five or more filtration modules. However, the number of the filtration modules is preferably even for the above-described reasons. Even in the case where the number of the filtration modules is even, it is not always necessary to clean half of all the filtration modules simultaneously; the filtration modules may be divided into groups each consisting of a certain number of filtration modules which is less than half the total number of the filtration modules, and a step in which a plurality of filtration modules are cleaned simultaneously may be conducted three or more times. Alternatively, a part of the filtration modules may be subjected to the second cleaning step (i.e., the step in which only one filtration module is cleaned) described in the method for operating the filtration apparatus 10 illustrated in FIG. 1.

While, in the above embodiments, filtration modules are cleaned simultaneously always in the same combination, the combination of filtration modules that are cleaned simultaneously may be changed in every cleaning step by changing the structure of the pipes or the like. However, it is preferable to clean filtration modules simultaneously always in the same combination in order to reduce variations in the degree of contamination among filtration modules that continue the filtration treatment without being cleaned.

The method for cleaning the filtration apparatus is not limited to the above-described backwashing by in-line cleaning in which cleaning water or a mixture of cleaning water and a chemical is used; another method or mean may be used for performing cleaning. The structure used for performing cleaning is not limited to the structures described in the above embodiments. That is, a pipe used for cleaning and a pipe used for collecting treated water may be provided separately from each other.

### REFERENCE SIGNS LIST

1a, 1b, 1c, 1d FILTRATION MODULE
2 WATER TANK
3 COLLECTION PIPE
3a FIRST PIPE
3b SECOND PIPE
3c MAIN PIPE
4 CLEANING PIPE
4a MAIN PIPE
5 CLEANING WATER TANK
10, 20 FILTRATION APPARATUS
V1 FIRST THREE-WAY VALVE
V2 SECOND THREE-WAY VALVE
P1 SUCTION PUMP
P2 FEED PUMP

1: A method for operating a filtration apparatus including three or more filtration modules, the method comprising:
a filtration step in which a filtration treatment is performed using the filtration modules; and
a cleaning step in which some of the filtration modules are stopped from performing the filtration treatment and the filtration modules stopped from performing the filtration treatment are cleaned simultaneously.

2: The method for operating a filtration apparatus according to claim 1, wherein, in the cleaning step, a plurality of filtration modules that have not been cleaned for the same or nearly the same amount of time as one another are cleaned simultaneously.

3: The method for operating a filtration apparatus according to claim 2, wherein a difference between the amounts of time during which the filtration modules have not been cleaned is 5% or less.

4: The method for operating a filtration apparatus according to claim 1, wherein the total number of the filtration modules included in the filtration apparatus is even, and half of all the filtration modules are cleaned simultaneously in the cleaning step.

5: The method for operating a filtration apparatus according to claim 1, wherein the amount of time during which cleaning is performed in the cleaning step is 0.3% or more and 5% or less of the amount of time during which the filtration treatment is performed.

6: A filtration apparatus including three or more filtration modules, the apparatus comprising:
a collection system that collects a filtrate from the filtration modules; and
a cleaning system that cleans some of the filtration modules simultaneously.
